(19) United States
(12) Patent Application Publication
(10) Pub. No.: US 2010/0312615 A1
(43) Pub. Date: Dec. 9, 2010

(54) Multi-Vendor Registration and Rewards System

(75) Inventors: Steve Murphy, Berkely, CA (US); Martin Riley, Renton, WA (US); Shari Marion-Hoff, Renton, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cohesion, Inc., d/b/a Hawkeye, Kent, WA (US)

(21) Appl. No.: 12/796,264

(22) Filed: Jun. 8, 2010

Related U.S. Application Data
(60) Provisional application No. 61/185,414, filed on Jun. 9, 2009.

(51) Int. Cl. G06Q 30/00; G06F 17/30; G06Q 10/00

(52) U.S. Cl. 705/11; 707/769; 705/14.11; 707/E17.014

(57) ABSTRACT

Systems and method to provide and encourage cross-industry collaboration between and amongst independent business partners designed to serve the needs of the indirect channel. Through the system, participating Members search for potential partners based on validated credentials across vendor ecosystems and professional certifications. Results can be further refined using additional filters including the use of keywords and location based attributes. Members review prospective partners' profiles and ratings, which may be obtained from fellow partners, to screen and select partners with whom they can share potential business through registered Customer Opportunities, i.e. Collaborations. Upon closing new business, the system provides tools to track each Collaboration's progress all the way through to the claims process where collaborating partners share in the aggregated Rewards earned from Sponsoring vendor organizations.

The present application claims benefit under 35 USC 119(e) to U.S. Application No. 61/185,414 filed Jun. 9, 2009, the contents of which are hereby incorporated by reference herein in their entirety.

### BACKGROUND OF THE INVENTION

Aspects of the present invention relate generally to opportunity registration and reward programs, and to methods and systems which allow multiple Sponsor (vendor) organizations to incent Member performance and collaboration on business opportunities.

Current business practices for indirect selling channel management include Partner Relationship Management (PRM) systems that are designed to fill the needs of vendor companies to collect, distribute and analyze information from their independent channel resellers and agents in order to better manage their overall customer portfolios. Within each of these proprietary channel partner ecosystems are many forms and tools designed to educate, support and reward the performance of the independent partners who successfully register customer opportunities and sell each vendor's products and services. Meanwhile, the independent partners provide value-added services for their customer from technical consulting, to installation and training to break/fix and Tier 1 and 2 customer support, including re-selling (or acting as the agent) products and services from many vendors.

Collaboration occurs whenever two or more independent business partner combine forces to address the customer requirements of one of the partner's customers. Complex customer requirements can often exceed the capabilities and capacities of a single independent partner. No utility, however, currently exists to support and reward partner-to-partner collaboration across multiple vendor ecosystems.

### BRIEF SUMMARY OF THE INVENTION

A Network of participating Members (partners) and participating Sponsors (vendors) is provided to allow Members to more effectively and efficiently collaborate with other Members in the network and to aggregate the rewards from many participating Sponsors using a single rewards media, e.g. a Collaboration Currency, to enable partners to more easily earn fungible rewards for their collaborative business-building behaviors.

In embodiments, disclosed systems and methods may provide a network-based environment configured to allow each Sponsor to determine the business rules for their participation (e.g. eligible partners, amount of rewards, etc.) within parameters established by the network. Once these rules are established, for example with program management utilities provided by the network, the Sponsor may agree to fund a common rewards media, referred to, for example, as a “Collaboration Currency”, through the network based projected revenues (registered opportunities) in the pipeline. As used herein, a Collaboration Currency may be understood as a rewards media that is provided by and through the network that is distinct from monetary currencies, and that may be used in various ways, such as redemption for a monetary currency and/or currencies, goods, collaborative credit, etc. The network may be configured to allow the Members to access those earnings based upon providing proof of performance to the network in mutually acceptable means (e.g. acceptable to the network and participating Sponsors).

In embodiments, the present invention may provide a web-based computer-implemented method for enabling Members to share in customer opportunities and collaborate for business.

Disclosed embodiments may include systems and methods configured to provide a Member Signup and Profiling module and/or routine, where users may be allowed to create a personal account, which may be used for a user login, as well as a company account, and/or a complete profile. Embodiments may include a Member Credential validation module and/or routine, where the system may support manual and/or automated validations of Member Company profiles, and the like, against other parameters and sets of parameters, such as Sponsor Partner program affiliations, individual certification claims, etc.

In embodiments, disclosed systems and methods may also support access to insight tools specifically provided by the network, including, for example, best practices information, collaboration success story case examples, ongoing discussion boards and wikis on topics of relevance to Members, and blogs from designated collaboration though leaders. Member connections may be facilitated through system functionality enabling Members to do searches to find potential collaboration partners based on profile information important to their customers' needs (e.g. geographic coverage, industry or technical expertise, vendor program affiliations and certifications, staff credentials and special business designation such as Minority-owned, etc.) Collaboration between Members may be system supported throughout a complete Customer opportunity lifecycle from pre-sale vetting and selection of collaboration Partners for a specific opportunity to closing the sale, and managing the service delivery process between the participating Partners.

According to embodiments, the systems and methods may provide a managing Partner means to submit proof of performance via a claims process that may incorporate the discretionary allocation amongst participating Partners of any Collaboration Currency reward earning.

Embodiments may include a computer-implemented method of executing and delivering incentive rewards in a collaborative network environment including electronically stored profiles for participating vendors and participating members. Order information, which may include a plurality of line items, may be received at a primary member station of a participating member. A confirmation request may be sent from the primary member station to a vendor station of a participating vendor. A response from the vendor station, which may include incentive information applicable to at least one of the plurality of line items, may be received at the primary member station. In embodiments, the incentive information may include a collaborative currency value and a satisfaction parameter.

According to embodiments, at least one secondary participating member responsible for performance of at least one of the plurality of line items may be identified. An advance commitment for at least part of the collaborative currency value to the secondary participating member may be entered and, after performance of the satisfaction parameter is reported to the vendor station, the primary member station may receive electronic credit for the collaborative currency value. In embodiments, the primary member station may distribute at least part of the collaborative currency value to the secondary participating member.

In embodiments, entering an advance commitment for at least part of the collaborative currency value may include the primary participating member designating a percentage of the collaborative currency value to be applied to the secondary participating member, and/or designating a discreet portion of the collaborative currency value to be applied to the secondary participating member. Electronic credit for the collaborative currency value may be configured to be further applied by the secondary participating member to other participating members and/or redeemed for cash.

According to embodiments, at least two of the plurality of line items may relate to separate participating vendors. Thus, embodiments may also include sending a confirmation request, such as from the primary participating member, to a respective vendor station for each of the separate participating vendors and/or receiving, such as at the primary member station, a response from respective vendor stations. In embodiments, individual responses may include incentive information applicable to the line item related to the respective vendor.

According to embodiments, at least two of the plurality of line items may relate to separate secondary participating members. Thus, embodiments may also include entering an advance commitment for at least part of the collaborative currency value to each of the secondary participating members and/or the primary member station distributing at least part of the collaborative currency value to the secondary participating members based on, for example, respective advance commitments, performance parameters, etc. In embodiments, reporting performance of the satisfaction parameter to the vendor station; receiving, at the primary member station, electronic credit for the collaborative currency value; and/or distributing the collaborative currency value from the primary member station to the secondary participating member, may be performed independently with respect to each separate secondary participating member.

In embodiments, identifying at least one secondary participating member may include sending an automated search request from the primary participating member to a database including the participating member profiles. The search request may include at least one of a participating member location, a participating member service location, sponsor qualifications, required certifications, and the like, as a search criterion. Embodiments may also include receiving, at the primary member station, a response to the search request including a list of participating members based on the search criterion.

According to other aspects of the invention, a computer-implemented method of executing and delivering incentive rewards in a collaborative network environment including electronically stored profiles for participating vendors and participating members, may be provided. Embodiments may include receiving, at a first vendor station for a first participating vendor, a confirmation request from a primary participating member. The confirmation request may include at least one line item related to the first participating vendor. Embodiments may also include sending, from the first vendor station, a response to the confirmation request including incentive information applicable to at least one line item. The incentive information may include, for example, a collaborative currency value, a satisfaction parameter and the like.

According to embodiments, evidence of performance of the satisfaction parameter may be received at the first vendor station and an electronic credit for the collaborative currency value may be sent to the primary participating member based on an analysis of the evidence of performance of the satisfaction parameter. The electronic credit for the collaborative currency value may be configured to be applied from the primary participating member to another participating member based on, for example, parameters established by the primary participating member.

Embodiments may also include automatically redeeming the collaborative currency value upon presentation by a second participating member that is different from the first participating member. Systems and methods may be configured such that the collaborative currency value may be redeemed for different currencies, goods, collaborative credit, etc. In embodiments, systems and methods may be configured to apply collaborative currency across national boundaries, areas with different monetary currencies, and the like.

Further aspects of the invention may include an automated collaboration and reward distribution system including a processor, an electronic network communication device, and an electronic storage device. Electronic storage devices may include, for example, non-transitory computer-readable storage media. The electronic storage device may include instructions that, when executed by a processor, such as a computer microprocessor, cause the system to perform steps including recognizing order information received by the communication device. Order information may include, for example, a plurality of line items related to the order. Embodiments may include instructions for sending a confirmation request, such as an automated confirmation request over a network via the communication device, to a vendor server of a participating vendor. Embodiments may include instructions for recognizing a response from a vendor server, including, for example, incentive information applicable to at least one of a plurality of line items. Incentive information may include a collaborative currency value, a satisfaction parameter, and the like.

Embodiments may include instructions for identifying at least one secondary participating member responsible for performance of at least one of a plurality of line items and/or entering an advance commitment for at least part of collaborative currency value to a secondary participating member. Embodiments may include instructions for reporting performance of the satisfaction parameter to a validation server and/or recognizing and accepting receipt of electronic credit for the collaborative currency value. Embodiments may also include instructions for electronically distributing all, or a part, of the collaborative currency value to a secondary participating member.

In embodiments, the validation server may be operated by a third party that is separate from the participating vendor, and/or the evidence of performance may be received at a first vendor station from a third party, the third party independent of the primary participating member and the first participating vendor.

According to aspects of the invention, and as discussed further herein, disclosed systems and methods may provide means for Members to better serve their respective customers by offering a broader range of products and services through collaboration with other Members.

Further advantages of the present subject matter will become apparent to those of ordinary skill in the art upon reading and understanding the following detailed description of the preferred embodiments.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a flowchart illustration providing a functional overview of an exemplary system according to an embodiment of the invention.

FIG. 2 is a block diagram depicting a high-level architecture of an exemplary system according to an embodiment of the invention.

FIG. 3 is a process diagram which shows an exemplary lifecycle of an opportunity according to an embodiment of the invention.

FIG. 4 is a high-level block diagram depicting aspects of acquiring and assigning collaboration currency according to an embodiment of the invention.

FIG. 5 is a schematic diagram showing aspects of a network-based system according to an embodiment of the invention.

### DETAILED DESCRIPTION OF THE INVENTION

It is understood that the invention is not limited to the particular methodology, protocols, and reagents, etc., described herein, as these may vary as the skilled artisan will recognize. It is also to be understood that the terminology used herein is used for the purpose of describing particular embodiments only, and is not intended to limit the scope of the invention. It also is be noted that as used herein and in the appended claims, the singular forms “a,” “an,” and “the” include the plural reference unless the context clearly dictates otherwise. Thus, for example, a reference to “a processor” is a reference to one or more processors and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The following preferred embodiments may be described in the context of a network-based system using host servers and client devices, such as the Internet, and may be adapted to various devices and communication networks without departing from the overall scope of the invention.

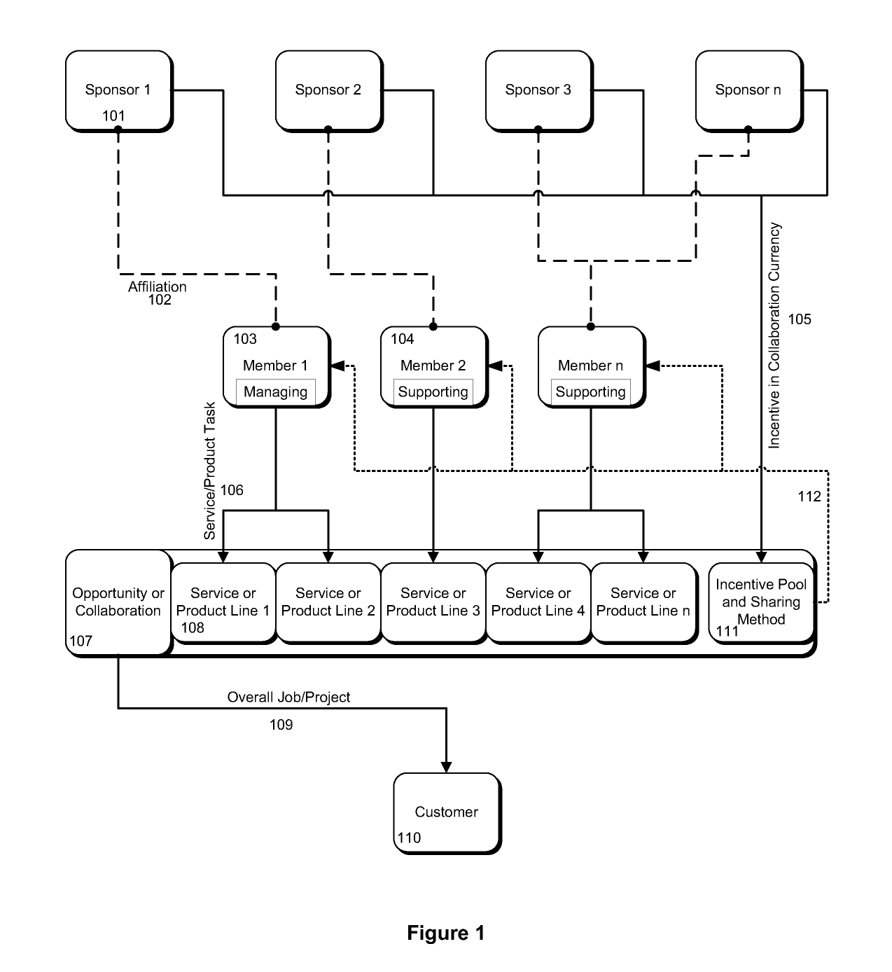

As shown in FIG. 1, embodiments of the invention may be applicable to business relationships between various entities including, for example, Sponsor (vendor) companies 101. The Sponsors 1-n 101 may be in communication over a network, such as the Internet, and may be linked to participating Members 1-n 103, 104. Members 103, 104 may be in further communication with various customers 110.

Sponsors 101 may include vendors or manufacturers organizations providing products or services through a distribution and fulfillment channel. Through the system Sponsors 101 may provide rewards or incentives when their products and services are sold through the channel.

Partner or reseller organizations of Sponsors 101 may include Members 103 who may be affiliated 102 to their respective Sponsors 101, such as by participating in partner programs, that may include obtaining vendor specific competencies, and the like.

Members 103, 104 serve their Customers 110 by providing solutions to their technology challenges and fulfill their needs with Products and/or Services 106 offerings.

When customer needs or Opportunities 107 extend beyond what a single member, e.g. Member 103, can provide, the system may allow a participant, such as Member 103, to search for, solicit support from and/or partner with other Members 104 to fill out the missing offerings and create a joint value proposition for the opportunity.

When an opportunity 107 is brought in to the network, the Member who owns the customer relationship is defined as the Managing Partner (member) 103 and those assisting in its execution as the supporting Members or partners, e.g. Member 104.

An Opportunity 107 may include the state or period of time during which the managing Member 103 is estimating the overall project requirements, negotiating with possible supporting Members 104 on what each would provide to the overall job/project effort 109.

As part of this process, the effort or opportunity 107 may be broken into specific line items 108 whereby each line may represent a product fulfillment or services task.

Each line item 108 may also be mapped or associated to a single Sponsor 101, although some line items may not. An example would be a line item which covers the purchase of a particular brand of computer servers, in which the brand manufacturer may become the sponsor for the respective line item 108.

Sponsors may allocate Member rewards and incentives 105 as a function of the line items which apply to them, e.g. through the use of a promotion managers and the like.

During the opportunity stage 107, estimated reward amounts may be given by the Sponsor 101 through the system in a Sponsor programmed or manual fashion. For example, a manufacturer may have a predetermined incentive applicable to a designated product that is applicable to opportunity 107, and/or may present targeted incentives to a particular opportunity 107 based on requests or other parameters. Thus, the system may support a broad and flexible mechanism for sponsors to offer incentives to participating members, and also encourage collaboration between participating members that use common rewards such as collaboration currency.

The Overall Job/Project 109 may be registered with each participating Sponsor 101 via a single-step, once a customer 110 commits to moving forward with the opportunity (in part or as a whole). Thus, the overall effort may mature from an opportunity to a registered collaboration 107, including predetermined sponsor-provided incentives 105.

At the point of collaboration, reward commitments from Sponsors 101 may determined and placed in abeyance for each applicable registered item, such as line items 108. The sum of all rewards mapped to a collaboration entity may be held by the system until the work is completed and a claim or proof of performance is made by a responsible party, such as a managing partner for each line item 108.

On a line by line basis, once the line item claims are approved by the system, the reward funds 112 may be transferred to the collaborating Members 103, 104 in a manner pre-determined by the Members 103, 104 yet controlled by the managing partner 103, as shown in 111. In embodiments, reward funds 112 earned through incentives 105 may include collaboration currency, that the system may recognize for further functionality, such as various redemption services.

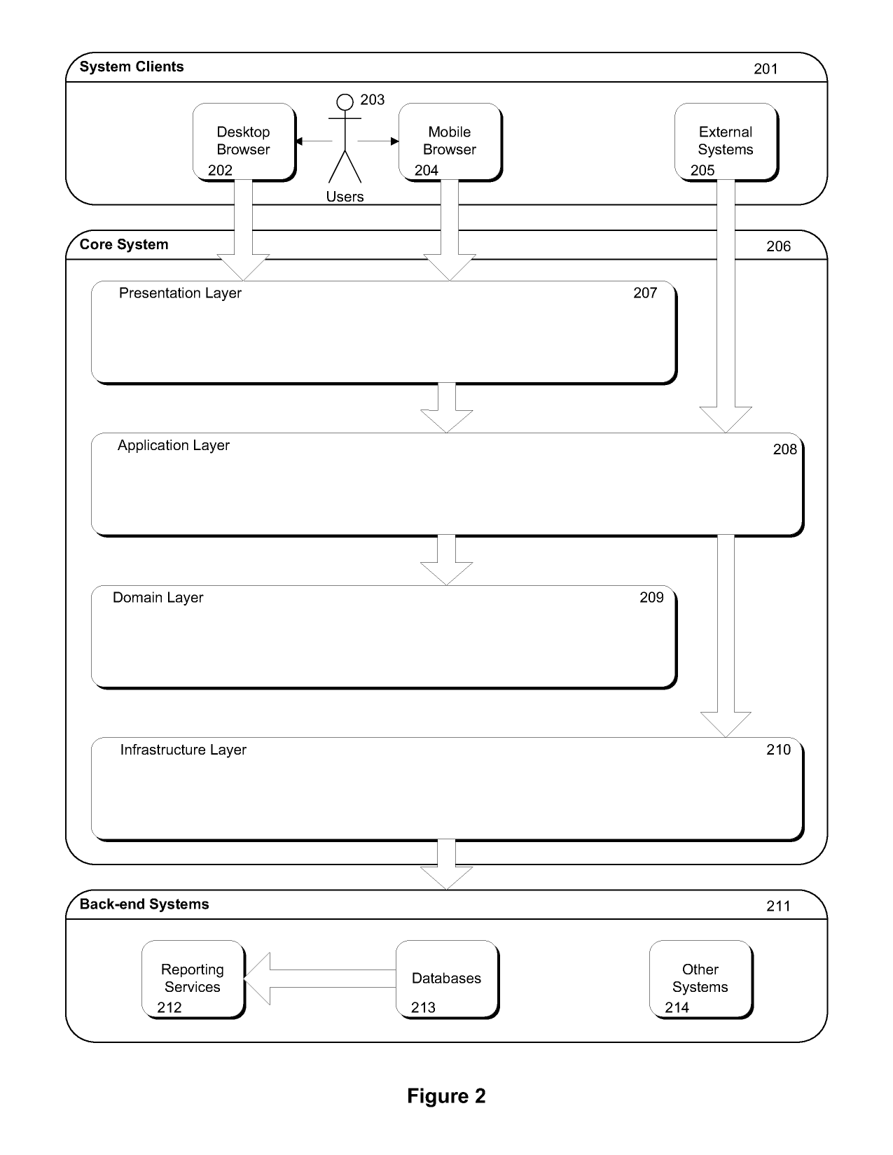

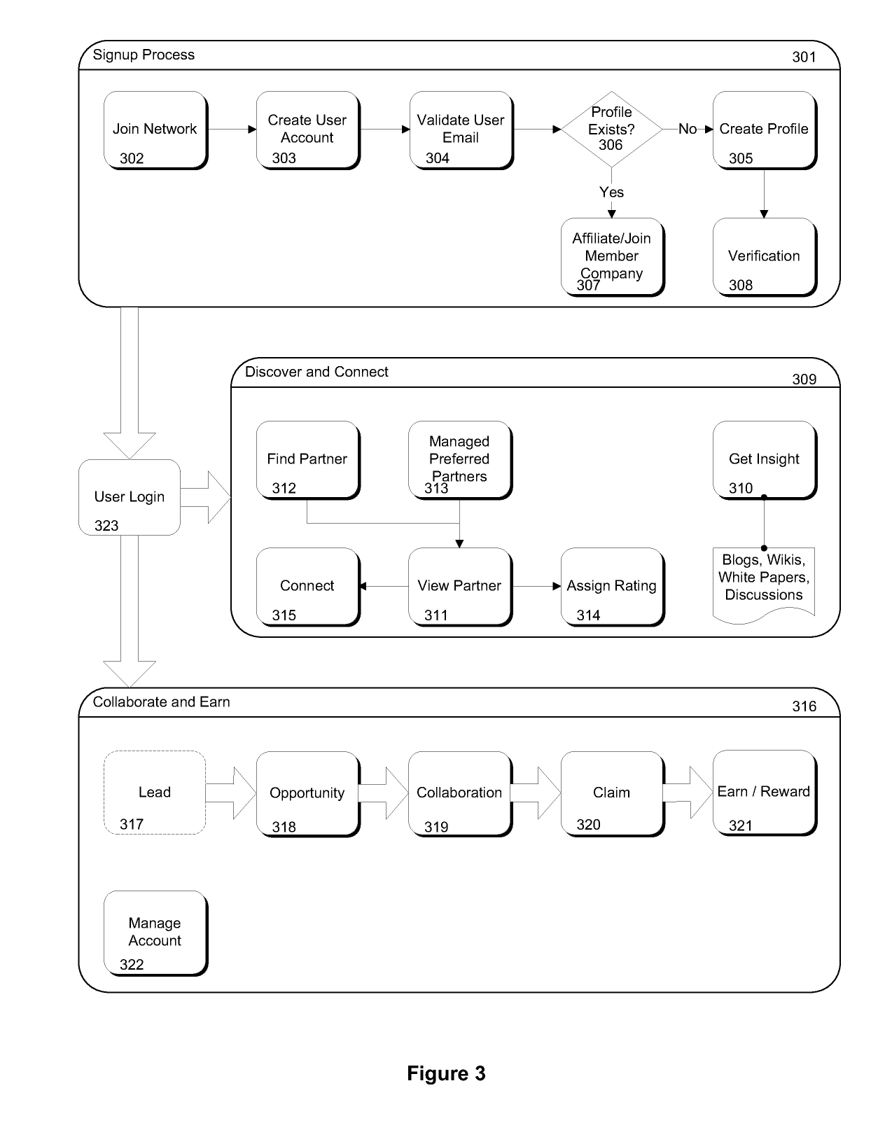

Additional aspects regarding an exemplary opportunity, collaboration and rewards lifecycle are with reference to FIGS. 2 and 3.

### System Architecture

As mentioned above, exemplary systems and methods may be implemented by way of a web-based platform such as shown in FIG. 2. In embodiments, the system may allow Members, such as a user 203, access through system clients 201 including, for example, web and mobile browsers 202, 204, as well as external systems and other clients 205 which may access the platform through a web service based application programming interface (API) 208 or Application Layer. External systems could be line of business systems, sites or programs which Members or Sponsors connect to the platform.

Exemplary core system 206 may be subdivided into layers, or modules configured according to programming instructions running on one or more microprocessors. Each layer/module may be configured to serve a specific purpose, and may, for example, be configured to reside on a single server, or multiple servers such as in a web farm environment. As shown in FIG. 2, exemplary layers/modules may include Presentation Layer 207, Application Layer 208, Domain Layer 209 and Infrastructure Layer 210.

The Presentation Layer 207 may include a web server layer configured for receiving and dispatching instructions from clients as well as presenting views and user interfaces. This layer may be based on a pseudo model-view-controller (MVC) pattern and may be, for example, configured as a client itself of the Application Layer 208. The actual Model resides in a Domain Layer 209.

The Application Layer 208 may include Services which coordinate tasks and delegate work to business objects in the Domain Layer 209. The Application Services may be configured to act as a Remote Facade to business objects and rules which inherently define the system.

A Domain Layer 209 layer may include system logic, containers, objects, structures, factories and rules of the business aspects of the system. Such features provide various functionality to the system, and facilitate and/or make available the business objects, and entities, to the system for processing and handling.

An Infrastructure Layer 210 may be configured to hold elements that are required, for example, as part of modern web platforms. This layer may include, for example, cross cutting concerns such as logging, data I/O, security, integration and others.

Behind the Infrastructure Layer 210, back-end systems 211 may be used to further support the platform. These may include web platform building blocks and include reporting services 212, database servers 213 and other systems 214, processes or methods as required.

### System Lifecycles

FIG. 3 illustrates aspects of three “lifecycles” or high level processes which may be performed according to systems and methods described herein. A first cycle 301 may be initiated, for example, when a user first joins 302 the network. Once a user is setup and their company is registered as a Member, the user can login and use the Discover and Connect features 309 or proceed to an opportunity or collaboration 316.

The signup process 301 may include a multi-step process whereby after the first step 302 a user may create a user account 303. Based on authentication credentials, which may be provided in 303, a validation process may be initiated to ensure, for example, the use of a valid email address in 304. The method may continue with 306.

In step 306 a determination may be made as to whether a member company profile exists. If a corresponding member company profile exists, the user may be joined to the existing company in step 307, e.g. if the user has an invitation to do so. Otherwise, a new Member company account may be created in step 305, which may also be validated in step 308, such as through the various Sponsors they represent in industry. This validation may be automated, such as by automatically sending confirmation messages, scanning white lists, and the like, or done through a manual process by the Sponsors. Exemplary systems may allow for more than one user to be assigned to a single Member company.

Once users are setup, they may login 323 to the system and can navigate various features, such as those features with permissions assigned to the corresponding Member company or individual user. For example, the user may be provided access to the Discover and Connect section 309, in which users may be given tools to find Partner Members 312, such as by specifying desired attributes they desire Partners to have. These attributes can be, for example, location based and/or driven by Sponsor qualifications and staff certifications. Search 312 can also be refined by the use of keywords and other techniques known in the art. In embodiments, Members can select specific partners to become “Preferred Partners” 313, which may be used, for example, to simplify communications and/or restrict opportunity item routing.

Throughout the system, users may be allowed to get a Member company's profile, such as in by viewing a potential or actual partner in step 311, and may be allowed to connect with the partner by contacting predetermined key contacts in connect step 315.

Ratings may also be assigned, for example by an authorized user, to Members in step 314, which may be used, for example, to measure and report on a Member's effectiveness in collaborating on efforts, the Member's ability to influence business opportunities, and other criteria relevant and/or unique to the collaborative environment. For example, according to embodiments, a Member may be ranked based on a demonstrated ability to partner in a particular collaborative role, such as service support and/or product delivery related to line items of a project. Thereafter, users may be better able to evaluate not only the Member's ability to deliver a product or service to a customer, but their effectiveness in delivering the product or service in a particular collaborative context, such as supporting partners in geographic regions, supporting designated service-type partners, and the like. Another area available to user is depicted as Get Insight step 310 and may include additional collections of information, based on, for example, web based tools including industry content, blogs, wikis and discussion forums, from which targeted information may be obtained.

With further reference to FIG. 3, a registered user may also access a business lifecycle of the system depicted as a Collaborate and Earn process 316. Process 316 shows aspects of an exemplary business flow, highlights of which are discussed below.

Leads 317 are typically sourced from vendors or other third party sources. A Lead may or may not precede an Opportunity 318, and may be targeted to specific Members or select group(s) of Members (e.g. preferred partners), or published to the entire network based on screening criteria.

Opportunities 318 are managed by Members (managing partners). They may be created directly in the system, e.g. by authorized users, or by converting a Lead 317. Supporting partners may be solicited and selected to assist/share work. In embodiments, supporting partners must be Members or become Members to qualify for any benefits available through the Network.

Collaborations 319 are registered opportunities 318 that have been toggled by a customer approving the project. Collaborations line items may be individually registered with Sponsors, and Sponsors may authorize reward funding upon the registration, as discussed herein.

Claims 320 result from performance of line items according to registered opportunities 318, and may be used to award rewards performed by the managing partner on a line item basis once a work item is completed. A claim 320 with proof of performance may be submitted to the system. Once approved, pre-designated incentives, such as Collaboration Currency, may be issued from vendors and distributed, for example, by the managing partner.

Rewards may be issued and distributed in step 321, and may include, for example, funds expressed in Collaboration Currency. Rewards may be converted to, for example, Cash, Transfers/Shares for supporting Partners, System Subscription dues, and/or Member Services Catalog which may provide options, such as, business-related services from authorized third-party providers to help Members improve their business' performance.

### Incentive Accounting

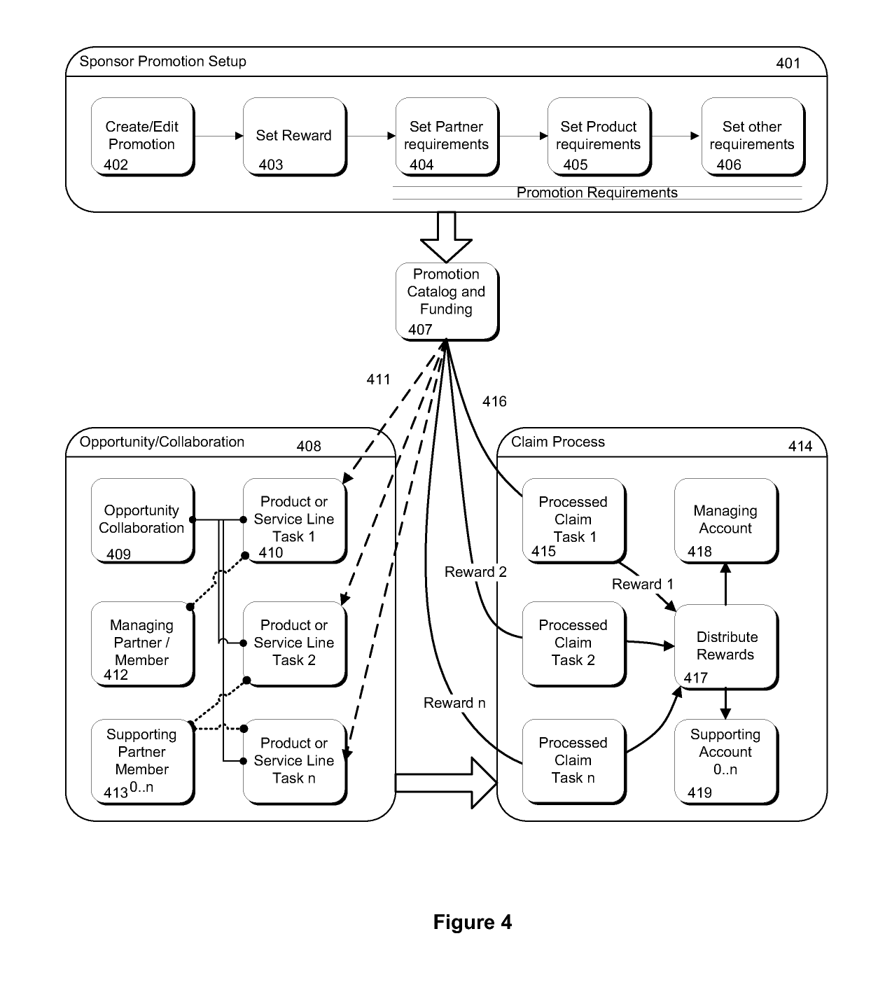

FIG. 4 provides additional details regarding exemplary systems and methods including aspects of an Incentive Accounting program. As shown in FIG. 4, Sponsors may set up their reward promotions 401 and designate how the promotions may relate to opportunities, collaborations 408 and the claim process 414.

In order for rewards to be made available to a Member, the system provides Sponsors with tools to create the promotion beginning in step 402, e.g. to set business rules on work items which drive funding types, and to set applicable rewards in step 403, as well as their applicability such as partner related parameters, e.g. partner tier, competency requirements, etc., and product parameters, e.g. types, categories, product requirements, etc., in steps 404 and 405, respectively. Other parameters may be set according to sponsor preferences in step 406, e.g. time limits, etc.

The collection of promotions from multiple Sponsors may be accomplished in step 407 and may be used for a Promotion Catalog which is used by the system to estimate various rewards 411 on work items 410 during the Opportunity and Collaboration phases 408, and to attribute actual rewards 416 upon the submission of actual work item claims 415.

With further reference to FIG. 4, opportunity/collaboration cycle 408 may include assigning line item responsibilities 410 of collaboration 409 to various supporting members 413 by a managing partner 412. For example, as discussed further herein, a managing member may be determined in step 412, and supporting members assigned in step(s) 413. Based on these designations, a collaboration may be created in step 409, including various line item related rewards 411.

As line items designated in step(s) 410 are completed, claims may be verified in step(s) 415, and rewards 416 processed to designated supporting accounts 419 via managing account 418. For example, the rewards earned may be distributed in step 417, such as by a managing account approval in step 418, to the other supporting Members in step 419.

PartnerConduit (PCN)

As discussed herein, the disclosed systems and methods may provide a PartnerConduit (PCN) that may include a business-to-business (B2B) application enabling independent reseller and influencer organizations (Partners) to aggregate and monetize the benefits of marketing programs from multiple manufacturer/vendor organizations (Vendors) and to redeem, reinvest or reallocate them using a common media, such as Collaboration Currency. Unlike current Partner Relationship Systems (PRM), wherein a Vendor can manage its own proprietary Joint Marketing Fund, Deal/Opportunity Registration and promotional marketing programs in a stand-alone environment, PCN replaces the stand-alone environment with a multi-Vendor approach that enable Partners to tap in to reseller marketing benefits the same way they conduct their B2B customer business, thereby combining the products/services of multiple Vendors and their own resources to provide a unique customer solution.

Unlike the proprietary Partner ecosystems, built on proprietary or PRM technologies, which are maintained by leading Vendors (and desired by smaller Vendors), the PCN encourages and facilitates Partners finding other qualified Partners with whom they can collaborate across industry boundaries.

For example, when Partner A can provide most of a unique customer solution using Vendor 1 and Vendor 2 products, but lacks some capability such as domain expertise, industry/vendor recognized certifications, vertical industry experience or geographic coverage to provide a complete solution, through the PCN application they can find Partner B with the verified bench strength and complementary skill sets to complete the specified assignment in the context it is needed. And when Partner B has the certifications and credentials to support the customer requirements for Vendor 3 products, the customer can be assured that they are using authorized, expert solution providers for the entire assignment.

As described above, a Partner Rating system provides PCN members with insight into how effective potential Partners are at working collaboratively, and can provide additional specialized information that is relevant to the particular collaboration project at hand. Current ranking systems and methods do not provide comparable information in a format to facilitate effective collaboration.

Additionally, by designing the interface from the Partners' perspective and on-boarding Vendors via a common process, PCN enables Partners to access all the participating Vendors via a single interface rather than having to navigate many different Vendor programs independently, in a resource-intensive process.

Since most Partners have more ‘active’ Vendor relationships (e.g. 20-30) than they typically manage to engage fully with (e.g. 4-6 ‘strategic’ Vendors) based on the way Vendors approach them, the PCN allows them to take more comprehensive advantage of all their ‘active’ relationships, such as by putting them in a profile once and then any time they are using a specific Vendors' eligible products/services in a customer opportunity, the system tracks its value in marketing funds, e.g. Collaboration Currency. This may enable a Partner to more efficiently source and sell multi-Vendor solutions which their customers demand but for which the reporting burden often left Joint Marketing Funds or promotional marketing rewards unclaimed.

The system may create reporting templates, using Vendor pre-authorized business rules that can automate such aspects as the lead distribution, registration, calculation, tracking and validation of all participating Vendor product/services Opportunities. For Vendors, this enables them to participate in a network or coalition of complementary products and services, combining their products and services with the products/services of other Vendors in the system under the management of a professionally certified and authorized Partner, while maintaining control of the business rules impacting their participation and funding of Joint Marketing Funds/promotions.

The application may track Partner-identified collaborations throughout the entire Opportunity lifecycle (Lead-Registered Opportunity-Sold-Delivered-Claimed), and shift control of the currency from Vendor to Partner upon completed proof-of-performance. For each Opportunity there is a Managing/Lead Partner (Partner A) and one or more Participating/Support Partners (Partner B).

For example, if Partner A identified and qualified an opportunity with a B2B customer requiring products/services including hardware (Vendor 1), general business software (Vendor 2), and a vertically specialized application software (Vendor 3) and also required Partner B to provide authorized service and support on Vendor 3 products, then the entire transaction may be entered and tracked within the PCN application.

Since Vendor 1 and Vendor 3 are both participating in PCN, the system may automatically track the revenues value and the Collaboration Currency commitment values based on each Vendor's customizable set-up. In this example, Vendor 1 is funding Collaboration Currency (CC$) at a rate of 1.25% of the Revenue Value, while Vendor 3 is funding at a rate of 1%. Vendor 2 is not in the PCN but the full details of the transaction are captured for the convenience of Partner A as the managing Partner.

Vendor Commitment and Partner Allocation Example

| | Customer | Collaboration | Collaboration |
|---|---|---|---|
| | Opportunity | Currency | Currency |
| | Revenue | Commitment | Partner |
| | Value | Value* | Distribution** |
| Vendor 1 | $20,000 | 250 | Not eligible |
| Vendor 2 | $22,500 | Not in PCN | Not in PCN |
| Vendor 3 | $40,000 | 400 | Not eligible |
| Partner A | $10,000 | 0 | 325 |
| Partner B | $7,500 | 0 | 325 |
| Total | $100,000 | 650 CC$ | 650CC$ |

Partners within the network are encouraged to share or redistribute common currency to contributing Partners that collaborated during the sale/delivery process, reinvest via network authorized service providers through a direct payment process to organizations providing services to promote business growth or offset business expenses, or they may redeem their Collaboration Currency for cash in their local currency. Thus, the disclosed common rewards currency used within the system is readily usable across boundaries, such as those arising from international borders and monetary currencies, in that the currency is fully useable within the system without reference to external exchange value and the like, until the time of redemption.

In the example above Partner A designates that 50% of the 650 in Collaboration Currency is to be shared with Partner B, or it could have designated that all or any percentage of the Collaboration Currency be redistributed to Partner B—at their discretion but in a manner transparent to Partner B using the Share function that is automatically managed within the system.

Independent of the desired allocation of Collaboration Currency designated by the managing Partner, each of the entities may derive incremental benefits through participation in the network and use of the application. For example:
Partner A benefits by retaining/growing an existing customer as well as through the efficiency of capturing marketing funds from a single process and from all participating Vendors. Partner B benefits by finding new business that may not have surfaced via other business development activities as well as from the potential for Collaboration Currency from Partner A.
Vendor 1 found new business and often at a lower operational cost than other sources of new business. Vendor 3 gets new business through a source that, heretofore, would have been very difficult to discover were it not for the Partner-to-Partner collaboration.

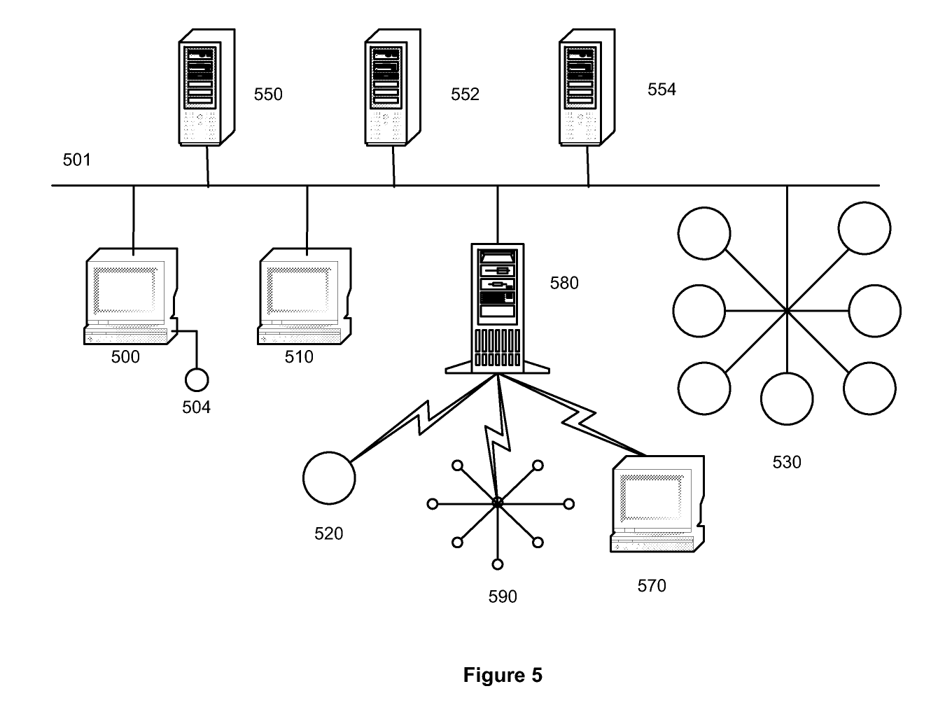

Embodiments of the present invention can include various configurations and systems for implementing the described methods, as well as computer-readable storage medium coded with instructions for causing a computer to execute the described methods. For example, as shown generally in FIG. 5, an electronic system 500 including a processor, a memory and an electronic communication device may be configured to initiate, forward, and/or receive, user registration, collaboration requests, and/or rewards distributions to, from and/or via a supporting server 550. One or more servers 550-554 may be configured to receive and process user requests, collaborations, vendor incentives, rewards, etc. The system 500 may represent a user computer system, wireless communication devices such as 520, 570, subnetworks such as 530, 590, a server, or any other network-capable device with the requisite functional capabilities.

The system 500 and servers 550-554 may include any number of processors (not shown) that are coupled to storage devices including a first storage (not shown, typically a random access memory, or “RAM”), second storage (not shown, typically a read only memory, or “ROM”). Both of these storage devices may include any suitable type of the computer-readable media described and/or mentioned above. A mass storage device (not shown) may also be used to store programs, data and the like and is typically a secondary storage medium, such as a hard disk that is slower than primary storage. It will be appreciated that the information retained within the mass storage device, may, in appropriate cases, be incorporated in standard manner as part of primary storage as virtual memory. A specific mass storage device such as a CD-ROM may also pass data uni-directionally to the processor.

As conventionally known in the art, a computer system, such as system 500, may also include an interface that includes one or more input/output devices such as such as video monitors, track balls, mice 504, keyboards, microphones, touch-sensitive displays, transducer card readers, magnetic or paper tape readers, tablets, styluses, voice or handwriting recognizers, or other known input devices, including other appropriately linked computers 510. The system 500 may be coupled to a computer or other electronic communication network 570, 580 using a network connection as shown generally at 501. The network can connect various wired, optical, electronic and other known networks to exchange information among computers 510, servers 550-554, 580, wireless communication devices 520, 570 and sub-networks 590, 530. With such a network connection, it is contemplated that the system 500 and the processor(s) therein may receive information from the network, or may output information to the network in the course of performing the above-described method steps. For example, a request to register a user, a collaboration, and/or an incentive may be forwarded from a system 500 to a server 550 via network 501. In embodiments, network server 550 may access information stored in another server or data source 552 in order to, for example, validate a requesting user, access account information, incentive details and the like. After the request is evaluated, a response may be sent from the server 550 to the system 500 via network 501, or other means. The above-described devices and materials will be familiar to those of skill in the computer hardware and software arts and need not be individually or exhaustively depicted to be understood by those of skill in the art. The hardware elements described above may be configured to act as one or more units for performing the operations described above.

In addition, embodiments of the present invention further include computer-readable storage media that include program instructions for performing various computer-implemented operations of the described methods. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

The invention has been described with reference to exemplary embodiments. Modifications and alterations of the described embodiments may be evident to those of ordinary skill in the art upon a reading and understanding of this specification. The present invention is intended to include all such modifications and alterations insofar as they come within the scope of the appended claims, or the equivalents thereof.

What is claimed is:

1. A computer-implemented method of executing and delivering incentive rewards in a collaborative network environment including electronically stored profiles for participating vendors and participating members, the method comprising:
receiving, at a primary member station of a participating member, order information including a plurality of line items;
sending a confirmation request from the primary member station to a vendor station of a participating vendor;
receiving, at the primary member station, a response from the vendor station including incentive information applicable to at least one of the plurality of line items, the incentive information including a collaborative currency value and a satisfaction parameter;
identifying at least one secondary participating member responsible for performance of at least one of the plurality of line items;
entering an advance commitment for at least part of the collaborative currency value to the secondary participating member;
reporting performance of the satisfaction parameter to the vendor station;
receiving, at the primary member station, electronic credit for the collaborative currency value; and
the primary member station distributing the at least part of the collaborative currency value to the secondary participating member.

2. The method of claim 1, wherein entering an advance commitment for at least part of the collaborative currency value includes the primary participating member designating a percentage of the collaborative currency value to be applied to the secondary participating member.

3. The method of claim 1, wherein entering an advance commitment for at least part of the collaborative currency value includes the primary participating member designating a discreet portion of the collaborative currency value to be applied to the secondary participating member.

4. The method of claim 1, wherein the electronic credit for the collaborative currency value is configured to be applied by the secondary participating member to other participating members and redeemed for cash.

5. The method of claim 1, wherein at least two of the plurality of line items relate to separate participating vendors, the method further comprising:
sending a confirmation request from the primary participating member to a respective vendor station for each of the separate participating vendors; and
receiving, at the primary member station, a response from each of the respective vendor stations, each response including incentive information applicable to the line item related to the respective vendor.

6. The method of claim 1, wherein at least two of the plurality of line items relate to separate secondary participating members, the method further comprising:
entering an advance commitment for at least part of the collaborative currency value to each of the secondary participating members; and
the primary member station distributing the at least part of the collaborative currency value to the secondary participating members based on the respective advance commitments.

7. The method of claim 6, wherein:
the reporting performance of the satisfaction parameter to the vendor station;
the receiving, at the primary member station, electronic credit for the collaborative currency value; and
the primary member station distributing the at least part of the collaborative currency value to the secondary participating member,
are performed independently with respect to each separate secondary participating member.

8. The method of claim 1, wherein the identifying at least one secondary participating member further comprises:
sending an automated search request from the primary participating member to a database including the participating member profiles, the search request including at least one of a participating member location, a participating member service location, sponsor qualifications, and required certifications, as a search criterion; and
receiving, at the primary member station, a response to the search request including a list of participating members based on the search criterion.

9. A computer-implemented method of executing and delivering incentive rewards in a collaborative network environment including electronically stored profiles for participating vendors and participating members, the method comprising:
receiving, at a first vendor station for a first participating vendor, a confirmation request from a primary participating member, the confirmation request including at least one line item related to the first participating vendor;
sending, from the first vendor station, a response to the confirmation request including incentive information applicable to at least one line item, the incentive information including a collaborative currency value and a satisfaction parameter;
receiving, at the first vendor station, evidence of performance of the satisfaction parameter; and
sending electronic credit for the collaborative currency value to the primary participating member based on an analysis of the evidence of performance of the satisfaction parameter,
wherein, the electronic credit for the collaborative currency value is configured to be applied from the primary participating member to another participating member based on parameters established by the primary participating member.

10. The method of claim 9, further comprising:
automatically redeeming the collaborative currency value upon presentation by a second participating member that is different from the first participating member.

11. An automated collaboration and reward distribution system comprising:
a processor;
an electronic network communication device; and
an electronic storage device,
the electronic storage device including instructions that, when executed by the processor, cause the system to perform the following steps:
recognize order information received by the communication device, the order information including a plurality of line items;
send a confirmation request via the communication device to a vendor server of a participating vendor;
recognize a response from the vendor server including incentive information applicable to at least one of the plurality of line items, the incentive information including a collaborative currency value and a satisfaction parameter;
identify at least one secondary participating member responsible for performance of at least one of the plurality of line items;
enter an advance commitment for at least part of the collaborative currency value to the secondary participating member;
report performance of the satisfaction parameter to a validation server;
recognize and accept receipt of electronic credit for the collaborative currency value; and
electrically distribute the at least part of the collaborative currency value to the secondary participating member.

12. The system of claim 11, wherein the validation server is operated by a third party that is separate from the participating vendor.

13. The method of claim 9, wherein the evidence of performance is received at the first vendor station from a third party, the third party independent of the primary participating member and the first participating vendor.
